(19) United States
(12) Patent Application Publication
(10) Pub. No.: US 2009/0210702 A1
(43) Pub. Date: Aug. 20, 2009

(54) SECURE APPLICATION SIGNING

(75) Inventors: Bharat Welingkar, Los Altos, CA (US); Rajesh Kanungo, Sunnyvale, CA (US); Srikiran Prasad, Santa Clara, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/361,468

(22) Filed: Jan. 28, 2009

Related U.S. Application Data
(60) Provisional application No. 61/062,758, filed on Jan. 29, 2008.

(51) Int. Cl. H04L 9/32; G06F 9/445; H04L 29/06

(52) U.S. Cl. 713/156; 717/178; 713/168; 713/175; 713/176

(57) ABSTRACT

A system and method for facilitating approval of an application and for making the application available for download by mobile computing devices has a first module configured to receive a user input received from a software development environment, a second module configured to initiate an application approval process based on the user input, and a third module configured to make the application available for download by mobile computing devices based on the approval process.

### CROSS-REFERENCE TO RELATED APPLICATIONS

This application claims the benefit of U.S. Provisional Application No. 61/062,758, filed Jan. 29, 2008, which is herein incorporated by reference in its entirety.

### BACKGROUND

A mobile computing device, such as a personal digital assistant, smartphone, mobile telephone, etc. may be configured to run applications which are loaded onto the device after manufacture or sale of the device. These applications may be developed and/or sold by the manufacturer of the device or by third party developers.

If a mobile computing device is allowed to load applications from third party developers, there is a risk of attack of the device and data stored on the device by viruses, hackers, spyware, and other malware. Security mechanisms can be used to thwart such attacks. However, some security mechanisms are costly and/or complex. Also, developers differ in their resources and preferences for different types of security mechanisms, some preferring security mechanisms which are low in cost or easier to implement.

In cryptography, a public key certificate (or identity certificate) is an electronic document which incorporates a digital signature to bind together a public key with an identity—information such as the name of a person or an organization, their address, and so forth. The certificate can be used to verify that a public key belongs to an individual.

In a typical public key infrastructure (PKI) scheme, the signature will be of a certificate authority (CA). In a web of trust scheme, the signature is of either the user (a self-signed certificate) or other users (“endorsements”). In either case, the signatures on a certificate are attestations by the certificate signer that the identity information and the public key belong together.

### BRIEF DESCRIPTION OF THE DRAWINGS

FIG. 1 is a flow diagram of a secure application signing system and method, according to an exemplary embodiment.

FIG. 2 is a schematic diagram illustrating the systems and entities which perform the steps of FIG. 1, according to an exemplary embodiment.

FIGS. 3A-3F are views of an exemplary mobile computing device which may be configured for implementation of the secure application signing system described in FIGS. 1 and 2, according to an exemplary embodiment.

FIG. 4 is a block diagram of a mobile computing device and server computer which may be configured for implementation of the secure application signing system described in FIGS. 1 and 2, according to an exemplary embodiment.

FIG. 5 is a flow diagram illustrating an exemplary signing process which may be used by one or more entities of the secure application signing system described in FIGS. 1 and 2.

FIG. 6 is a flow diagram illustrating an exemplary verification process which may be used by one or more entities of the secure application signing system described in FIGS. 1 and 2.

FIG. 7 is a flow diagram illustrating an exemplary revocation process which may be used by one or more entities of the secure application signing system described in FIGS. 1 and 2.

### DETAILED DESCRIPTION OF EXEMPLARY EMBODIMENTS

The systems and methods described herein may have one or more of the following advantages: low cost application signing for developers, application signing which is easy to use for developers, improving trust by a user of downloadable applications and the mobile computing device to which the applications are downloaded, reduction of malware, fraud, and other security breaches when downloading applications to a mobile computing device, reduced forgery of programs, brands and/or publishers of downloadable applications, improved notification to a user of unapproved applications and applications having an expired certificate, empowering users to allow downloads of unsigned applications or applications not approved by a manufacturer of the device, empowering users to allow downloads in spite of notifications or warnings about downloadable applications, and allowing better control by the manufacturer of the device over the cost, complexity, and/or level of security of the process of approving, authorizing, or signing applications.

An end-to-end process of identity creation (for a developer using the application signing system) and on-device certificate validation is disclosed. The identity creation may be implemented with a web portal to a server computer which performs identity verification and automation of certificate issuing. A mobile computing device may validate the issued certificates during an application installation or download process and implement one or more predetermined access policies.

A manufacturer of a mobile computing device may sign applications, generating its own certificates. The manufacturer may act as an intermediate certification authority (CA), using resources of a third party CA. The mobile computing device may be configured to provide access to more resources on the device to a CA-certified, signed application than to a non-CA-certified, signed application. The mobile computing device may be configured to download, install, and/or launch non-signed applications, applications signed by a third party CA, and applications signed by the device manufacturer or CA associated with the device manufacturer, though in some embodiments the resources on the device available to the application may be more or less than the resources available to other applications depending on whether and how the application is signed.

Preparing to Develop Applications

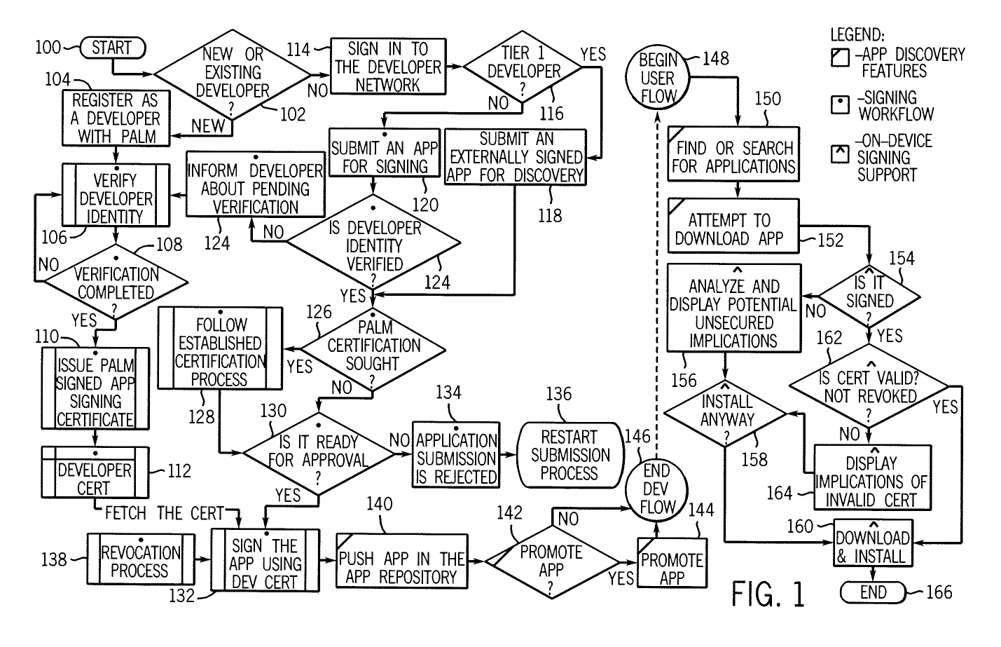

Referring now to FIG. 1, a flow diagram of a secure application signing system and method is shown. The system and method is described with reference to a flow diagram in which each step may be considered a module or unit configured with appropriate logic or code (e.g., software) and/or hardware (e.g., processing circuitry) to perform the functions discussed herein. Each of the modules may operate on one or more server computers, such as a server farm. Mobile computing devices, such as those described herein, may be configured to download applications made by developers from a server (e.g., over the air via a wireless signal, such as cellular or IEEE 802.11x, or via a wired interface to a network, for example through a computer). The server (e.g., one or more computers, processors, etc.) may be configured to receive applications from one or more developers and store them for subsequent downloading to one or more mobile devices. A developer first registers, prepares or otherwise signs up to use the system. A developer may be an entity (e.g., individual, corporation, etc.) which develops one or more portions of a software application operable on a mobile computing device. A device manufacturer (e.g., Palm, Inc. of Sunnyvale, Calif.) may provide information to a developer to assist the developer in creating the software application in a manner which is compatible with the device. The developer may be known or unknown to the device manufacturer. In this exemplary embodiment, the device manufacturer provides the developer with certain information, such as: an SDK (Software Development Kit), which may comprise a collection of software tools and specifications that allows a developer to build and test an application operable on a mobile device; a JNLP (Java Network Launch Protocol) framework specification, which may comprise a specification defining how an application is to be launched on the mobile device; information regarding how to embed a logo (e.g., an icon, a graphic, image file, etc.), one or more trust ratings and other information in JARs (Java Archive files) stored in a META-INF directory which forms the downloadable application; and information regarding how the device manufacturer may sign vendor-specific logo and certification, which the developer is to place in a file with a predetermined file name to be placed in a manifest directory of a JAR. The JNLP is a protocol that defines how applications can be downloaded and launched using the Internet. Other protocols may be used. “Trust ratings” are tokens (e.g., objects or other code) inserted in the package which can be inspected by the mobile device at the run time to additionally decide other privileges (other than launching). JAR is a package format and developers generate JAR using packaging tools provided by the device manufacturer. JARs are created by the developer and submitted to the device manufacturer for signing and after signing are uploaded to an application catalog. A META-INF directory is a file created by the developer using the IDE during creation of the application.

The device manufacture may further provide the developer with a software program, which may comprise a plug-in to an integrated development environment, such as Eclipse, or other software program. Eclipse is an open source community, whose projects are focused on building an open development platform comprising extensible frameworks, tools and runtimes for building, deploying and managing software across the lifecycle. The software program may be configured to initiate, plan, and/or automate at least one of a registration, verification, signing, delivery, upload and publication step associated with the downloadable application and/or the developer. The software program may comprise a button or menu item selectable in an integrated development environment or other source code editor, compiler and/or interpreter, automation tool, and/or a debugger. Upon selecting the button or menu item, a message may be sent to the device manufacturer or other party authorized by the device manufacturer requesting the initiation of a signing, delivery and/or publication function. In response, a server computer associated with the device manufacturer may initiate one or more of such functions.

The device manufacturer may further provide the developer with information regarding available testing and verification approaches, such as those described below with reference to FIG. 1. Several options exist for a developer to have an application tested, signed, approved, and/or authorized for download to mobile device users, which are shown in exemplary form in FIG. 1 beginning at start step 100.

The device manufacturer may also provide other information to the developer for developing the application with proper security features. For example, the device manufacturer can indicate that the developer may declare services that the application is configured to use. In a security tag or other file defined by the JNLP, or in the JAR, a security file or code portion is configured to store a list of services (e.g., applications, web sites, or others services) used by the application. This list can assist the server in assessing security risks during a testing process carried out by the server. The plug-in software program may be configured to create the file, such as a manifest, based on information about the services retrieved from the IDE, whether from the software code, user, or other data sources. The services may be actual interfaces or interface programs or groups or categories of interfaces or interface programs. Groups and categories may use XML schema annotation to expand into actual interfaces or may be expanded internally. According to one embodiment, the IDEs cannot detect services accessed by reflection and, therefore, the developer must declare such services expressly. Reflection is a computer programming method by which a user of the system can introspect the capabilities of the system, which allows the user to dynamically develop its own behavior. The use of protected classes may be limited to specific vendors or developers.

The developer uses the information provided by the device manufacturer to develop one or more applications which will be compatible with the device manufacturer's mobile computing devices and secure application signing system and method. When one or more applications are ready for uploading, the process proceeds at step 102.

In FIG. 1, at step 102, a server computer is configured to determine whether a new or existing developer is requesting the signing of a new downloadable application. Step 102 may be entered from a plug-in in an IDE configured to initiate a signing, delivery and/or publication process. It can also be initiated via a developer visiting a signing portal or other web site hosted by a device manufacturer. The server may be accessed via a network, such as the Internet. The server computer may request one or more credentials or other identification data from the developer and compare the received data to previously stored data in a memory to determine whether the developer is new or has previously used the system. If the developer is new, at step 104, the server provides a user interface configured to collect information about the developer to begin a process of registering the developer.

Registering as a Developer with the System

A developer may visit a device manufacturer network web site, operable from a server computer and accessed via the Internet, and request to become a developer with the device manufacturer. The web site server is configured to send display data indicative of an on-line form for the developer to fill out. Once the developer fills out the form and requests registration with the device manufacturer server (step 104), an identity verification process will be triggered or initiated by the server (steps 106, 108, described below).

A signing portal server computer (which may be the same server computer or a separate server computer from that which provided the on-line form) may be configured to verify the developer identity (step 106) and issue a certificate, such as a device manufacturer-signed application signing certificate (step 110). The signing portal server may be operable by the device manufacturer or an authorized third party. According to one embodiment, one or more of these steps may occur without requiring human interaction (i.e., automatically). The signing portal server may be configured to operate one or more of the following algorithms. In an identity verification process (step 106), the server may be configured to verify or validate an identity of a developer based on an email identity and/or other indentifying information (e.g., received using the on-line form), in a scenario in which the device manufacturer acts as a certification authority. The device manufacturer may use one or more automated or manual authentication techniques, such as checking information available from government bureaus, checking information available in a payment infrastructure, checking third parties' databases and services, and using custom heuristics to prevent automation of identity creation by spammers. The server may use an e-mail identity and/or other publicly verifiable information to verify the identity of the developer, which may include determining whether the requestor is a spammer or other unwanted requestor and preventing verification of the identity if the requester is unwanted. The server may be configured to generate a one-time certificate for the developer which keeps a private key safe. The server my also be configured to generate a private key for each developer. A one time certificate is valid for only one specific application upload.

According to one embodiment, the server may be configured to use one or more of the concepts of community trust. The server may be configured to re-issue certificates (e.g., a same certificate previously issued) verifying the identity of a developer for use with multiple applications, if required or requested. The server may be configured to base verification on one or more ratings collected by the signing portal, the ratings being based on end-user ratings of the application, number of downloads of the application, usefulness to the community of the application, third-party testing of the application, change in the trust-worthiness of a vendor, etc. One or more steps of the verification and/or certificate generation process may be done with the use of a third party CA, which may communicate and share information with the server.

According to one embodiment, the server may be configured to process multiple certificates for a single application. Multiple identities for a single application may be acceptable. For example, a single software application can be developed by more than one developer and therefore more than one developer identity may be associated with the application, each developer having its own certificate stored in association with the application.

If verification is completed (step 108), the server is configured to issue an application signing certificate (or other form of authorization or approval) to the developer at step 110. The server may further be configured to store the certificate, since it may be configured to be the master record holder of trust.

Uploading an Application

The developer can then sign into the system to upload an application, starting with step 102, wherein the developer is now a known, existing developer. Once a developer is known, the signing portal server is configured to provide a user interface configured to receive a sign-in request from the developer and to receive an upload of an application at the developer network or web site at step 114.

At step 116, if the developer is a Tier 1 developer (e.g., a Tier 1 developer may be a corporate partner or other developer given a predetermined designation or ranking by the device manufacturer), the developer has obtained an externally signed certificate for its application, and the externally signed application is submitted at step 118 to the signing portal server to be discovered by end-users. For example, the system may be configured to provide a web site to allow the user to browse one or more lists of applications available for download or purchase. An externally signed certificate refers to an application which is signed by an independent certification authority or tester other than the device manufacturer (E.g., VeriSign, Inc., of Mountain View, Calif., Comodo Group, Inc., Jersey City, N.J., GoDaddy.com, Scottsdale, Ariz., or other CAs). The certification authority may charge a fee for the signing process. If the developer is not a Tier 1 developer, at step 120 the application may be submitted to the device manufacturer for signing via the signing portal.

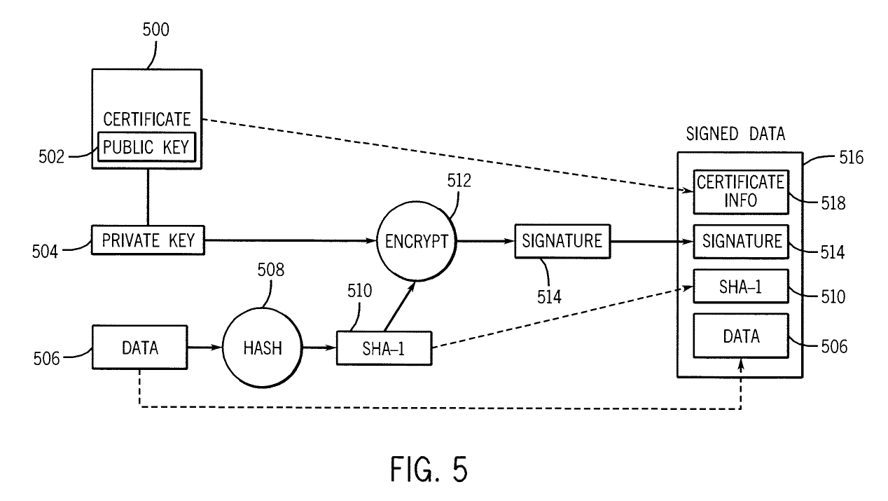

At step 122, the signing portal server is configured to determine whether the developer identity is verified and, if not, the developer is informed (e.g., by an electronic communication, phone call, etc.) that the verification is pending at step 124 and the process continues at step 106. If or when the developer identity is verified, at step 126 the server is configured to determine whether the developer is seeking certification from the device manufacturer. A certification process may be carried out by the device manufacturer at step 128, which may use one or more authorized testing partners to verify the compatibility of the application to the system's application discovery platform. The server itself may also be configured to run a test algorithm against the application to certify the application has met one or more criteria, such as, compatibility, no malware, services used by the application are approved or safe, or other certifications. Certification may comprise a process of verifying and accepting the application software from a developer by the device manufacturer and may comprise technical and/or business processes. If certification by the tester is acceptable to the device manufacturer at step 130 based on the application having met one, two, or more criteria, the downloadable application is electronically signed at step 132 using the developer certificate. For example, the exemplary signing algorithm shown in FIG. 5 may be used. If the certification is not acceptable, at step 134, the submission of the downloadable application is rejected at step 134 and the submission process may be restarted at step 136.

The device manufacturer may accept applications approved, authorized, certified and/or signed using different methods or cycles. One exemplary cycle is where the Developer, Device Manufacturer and a Tester are involved, as will now be described. In this method, the server receives an upload of the application from the developer, using the signing portal (step 120). The server is configured to transmit the application to a tester server and/or to operate one or more test steps on the application. The developer may initiate testing using authorized testers (step 126-128). The testers may be the device manufacturer or an entity authorized by the device manufacturer to test or certify the application for compatibility, feature verification and other portability. Test results or reports are received from the tester at the server and may be presented to the developer and/or device manufacturer. If the application passes the tests, the server may sign the application (step 132). The developer finalizes and pushes the final application to the signing portal server which gets signed by the device manufacturer (step 132) using the developer certificate created at steps 110-112 and retrieved from a memory accessible by the server (either stored during steps 110, 112 or received from the developer). The developer certificate may be stored at the server for retrieval based on the identity of the developer received during sign-in, or may be submitted by the developer at the time of submitting the application for upload. According to one embodiment, the tester may co-sign the application using a tester certificate and reports results to the device manufacturer. The signing portal server may be configured to insert a manifest file in the JAR or other file associated with the downloadable application (step 132). The device manufacturer then publishes the application in an application directory so it can be discovered by the end-user using their mobile device (step 140).

Referring now to FIG. 5, an exemplary signing process will be described, which may be used at step 132 or other steps where signing may be required. A developer may have an associated certificate 500, which may comprise a public key 502. The developer may also have a private key 504, which may alternatively be a private key stored and known only to the device manufacturer, or other operator of the signing system and method of FIG. 1. A data 506 to be signed, such as an uploaded application or one or more files of an uploaded application will be signed in this process. A hash module 508 is configured to provide a hash function of data 506, for example using an SHA-1 hash function 510. An encrypt module 512 may be configured to encrypt the hashed data using private key 504 to generate a signature 514. A signed data module is configured to generate signed data 516 which comprises certificate information 518 (e.g., one or more portions of data from certificate 500) from certificate 500, signature 514, the hashed data 510 and the data 506. The signed data 516 thus provides a digital signature which verifies the source or identity of data 506.

One algorithm for signing the application is to use a Java JAR signing standard. A Java JAR manifest file associated with the application to be uploaded, MANIFEST.MF, will contain a list of files that need to be signed. Each file that is signed has a name entry in the MANIFEST.MF file in a META-INF directory specified as a relative file path or a URL (pointing to a memory at which the file is stored) and an attribute data designating the digest algorithm (e.g., SHA-1, MD5, RIPEMD-160, or other digest algorithms) and the actual digest value encoded in base-64. A signed JAR also has a signature instructions file, which may end with a .SF extension in the META-INF directory. The .SF file may be named signer-name.SF. According to one exemplary embodiment, there can be multiple signers. For each signer, designated by signer-name, there is a corresponding signer-name.SF file.

Each file entry in the MANIFEST.MF file has a corresponding entry in the signer-name.SF file with the same relative file path or URL and a corresponding digest entry calculated over the file entry in the MANIFEST.MF file. For each signer-name.SF file, there is a corresponding Signature Block File with an extension type based on the signature algorithm used. For example, if an RSA encryption algorithm is used, then a signer-name.RSA extension is used. The Signature Block file may be a digital signature or electronically signed version of the signer-name.SF. The syntax and format of the Signature Block file is based on the signing algorithm used (e.g., RSA, DSA, or some other algorithm). In common Java digital signing parlance, a JAR file with multiple signers is considered to be co-signed. For each co-signer, there is a corresponding signer-name.SF file and a signer-name.RSA or signer-name.DSA or signer-name.signing algorithm, file.

Another exemplary cycle for signing is provided wherein only the developer and device manufacturer are involved, in which the server receives an application uploaded by the developer to the signing server (step 120) and the server signs and publishes the application with appropriate vendor or developer information (step 132). The server may be configured to re-sign the application again based on performance or ratings (e.g., well performing/rated applications based on user or device manufacturer experience), which may be stored in the manifest file (step 132). A server portal may be configured to receive and store ratings based on number of downloads, user responses or evaluation data, remarks from an application catalog, etc., and this rating data is available to the signing server which is configured to manipulate the manifest.

Revocation of Certificates

At step 138, the server may be configured to implement one or more steps of a revocation of identity process. For example, a certificate revocation list (CRL) may be maintained or stored in memory, which is a list of certificates (or serial numbers for certificates) which have been revoked, are no longer valid, and/or should not be relied on by any system user. The CRL may comprise certificates revoked, on hold, expired, etc., based on instructions received from the device manufacturer, which may be based on user comments or other information. If a certificate is on the CRL, at step 132, the application will not be certified and/or will not be signed at step 132. The server may be configured to transmit, deliver or push the CRL or portion thereof to mobile computing devices, which may occur at one or more of the following times/events: on-demand (e.g., upon request from the mobile device, such as during a log-in session to another service offered by the device manufacturer), scheduled push (e.g., periodically) from the server, etc. A processing circuit on the mobile computing device is configured to determine prior to downloading an application from any site whether the application has an approved or revoked identity by comparing a certificate of an application to be downloaded to the CRL downloaded onto and stored in memory on the mobile computing device.

According to one exemplary embodiment, the certificate or developer revocation list may be signed by the server, such as by the device manufacturer or by a third party certificate authority. A Certificate Revocation List (CRL) may comprise a list of certificate serial numbers issued by the Certificate Authority, whether the device manufacturer or a third party. The list comprises those certificates that have been revoked by the CA. The list is signed by the CA in order to ensure that the reader of the list has a guarantee that the certificate revocation list is authentic. According to one embodiment, when the device manufacturer issues a CRL to mobile devices, it will sign the certificates using its private key corresponding to the certificate which is the root of the certificates issued to the vendors. Alternatively, or in addition, the CRL may be signed by a third party CA. The CRL may be compiled by and stored by the signing portal server and/or by a third party CA. In either case, the one or more CRLs may be delivered to the mobile computing devices in an automated manner.

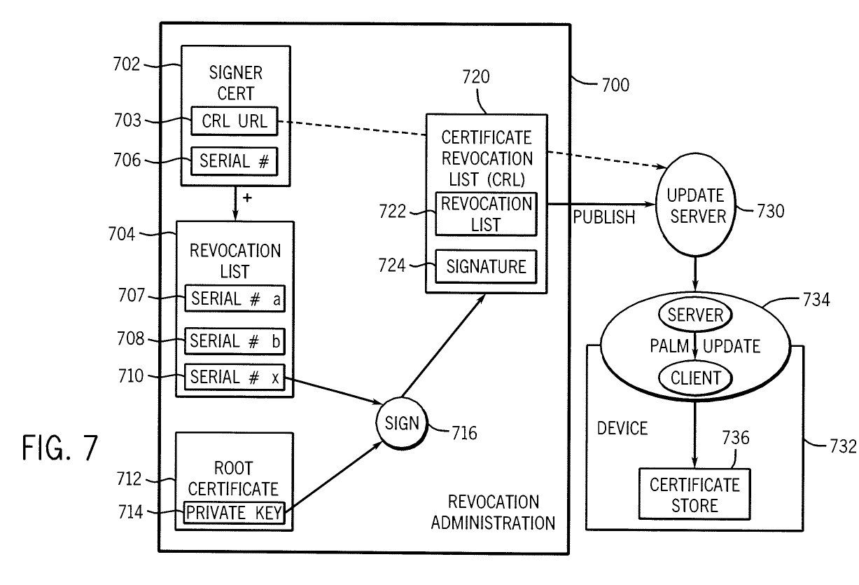

Referring now to FIG. 7, an exemplary system and method for revocation will be described. A revocation administration module 700 (e.g., one or more software algorithms operable on the signing portal server or other server) is shown comprising portions or modules stored in memory as code. Module 700 comprises a signer certificate comprising a pointer or URL 703 to a revocation list file 704 and a signer serial number 706. Revocation list 704 comprises serial number a 707, serial number b 708 and serial number x 710 (representing one or more additional serial numbers). The serial numbers 707, 708 and 710 correspond to one or more certificates that have been revoked by module 700 based on information indicating the developer and/or applications associated with those certificates should no longer be used, trusted, etc. A root certificate 712 comprising a private key 714 is also provided.

A signing module 716 may be configured to sign (e.g., using the process of FIG. 5 or another signing process) the revocation list 704 using root certificate 712 and signer certificate 702 to provide a certificate revocation list (CRL) 720. CRL 720 comprises the now signed revocation list 722 and a digital signature 724 based on the signer certificate 702 and root certificate 712.

Revocation administration module 700 is configured to publish or transmit CRL 720 to an update server 730 (which may be a portion of the same server operating module 700 or a different server). Update server 730 is configured to provide an update of one or more CRLs stored on one or more mobile computing devices 730. As described hereinabove, an update process 734 may be carried out by push and/or pull operations between server 730 and device client 732 periodically, in response to a manually-activated push request at server 730, in response to a manually-activated pull request from device 730, or at other times or using other methods. CRL 720 is stored and/or updated in a memory on device 732, such as certificate store 736. Alternatively, other revocation update or administration processes may be used.

At step 140, if an application is approved (step 130), signed using a developer certificate (132) and/or Palm certificate (step 128), and neither certificate is on a CRL (step 138), the application is pushed, transferred, or uploaded to a server (e.g., to an application repository). At step 142, if the device manufacturer is to promote the application (because it is from a preferred partner, or based on functional usage), the application is promoted (step 144) by, for example, a wireless carrier or mobile network operator (MNO) may prefer to show certain applications to end-users before non-featured applications. At step 146, the application is available for download.

User Search, Selection and Download of Application

A user (e.g., end user of mobile computing device) flow begins at step 148. At step 150, a server is configured to receive a request from a user through the mobile computing device (e.g., via an Internet browser, dedicated software browser for downloading applications such as an application discovery application, etc.) to browse, search or view descriptive information about applications available for download, such as, type, category, title, cost, etc. For example, a “find applications” input device may be selected on the mobile device (e.g., via a touch screen input, soft key input, etc.) using an applications launcher. The server may be configured to receive one or more keyword search requests from the mobile device to search or browse categories. An application of interest is then identified by the user. At step 152, a request to download is received from the mobile device. The applications may be downloaded from a server or web site associated with the device manufacturer, a server or web site associated with a party authorized by the device manufacturer, or a server or web site unassociated with the device manufacturer. The server is configured to locate the application (e.g., via a URL, database identifier, etc.).

A JNLP file or program, or other application launcher, may be used by the mobile computing device. JNLP files will typically have a jnlp extension and will have a mime type of: “application/x-java-jnlp-file”. The application launcher may be configured to display to the user one or more of the following: a description about the vendor or developer of the application, a name and description of the application and its version, runtime information including the version of Java and the operating system(s) compatible with the application, resources on the mobile device that the application will use including JAR files, hardware, software, and optional version requirement information, security information (such as security risks associated with the application, when eh application was signed, who signed the application, etc.), launching information, and/or application update guidelines.

The mobile computing device is configured to download and cache all files in the JAR, zip file, or other files associated with the user-selected application. A security verification unit on the mobile device is then invoked to determine whether the application to be downloaded is signed (step 154). According to one exemplary embodiment, during manufacture the mobile computing device has a known value stored in flash memory which cannot be easily modified due to a security mechanism. When the application is downloaded, the certificate downloaded with the application has data which can be reverse calculated using a known algorithm. The mobile device is configured to perform the reverse calculation operation on the certificate and compare the results with its own known value store to verify. Other verification processes are contemplated. If the application is not signed, the mobile device is configured to analyze the application files and determine any implications, risks, etc. relating to the application and display information about the implications, risks, etc. to the user (step 156). A user input may be provided to allow the user to cancel the install, download anyway, or learn more about the application. If the user chooses to install in spite of the application not having a signature, at step 160 the application is downloaded, unzipped, etc. and installed on the device.

If the application is signed, at step 162 the device checks a predetermined list of valid and/or revoked certifications to determine whether the signature has been revoked, put on hold, etc. If so, implications of the invalid certificate or signature are displayed at step 164 and the user is given the option to download anyway at step 158. If the certificate is valid and not revoked, the process continues at step 160 to download/install, before ending 166.

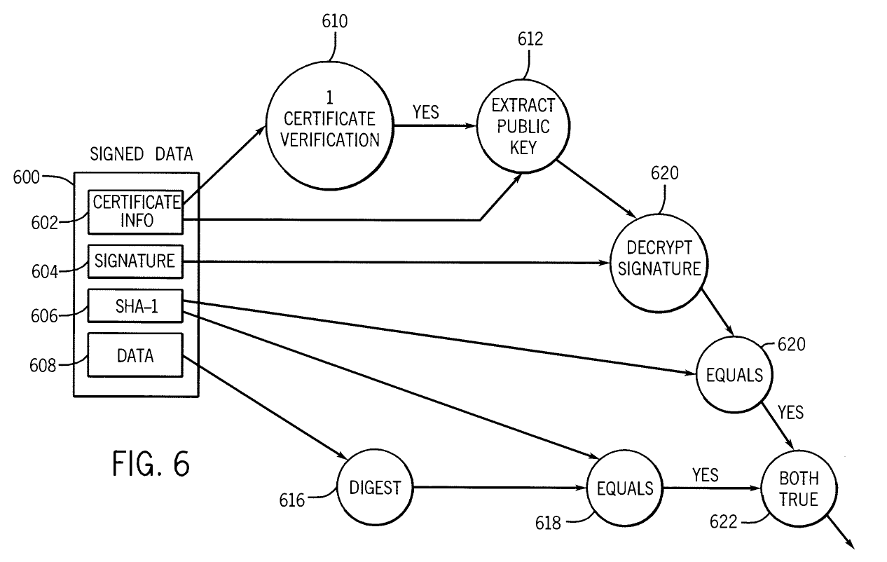

Referring now to FIG. 6, an exemplary process of verification will be described, which may be used at step 162 or other steps in the system and method to verify a signed data. The verification process may be operable by a processing circuit on the mobile device, or by a server. In this exemplary embodiment, the mobile device processing circuit is configured to receive signed data 600 comprising certificate information 602, a digital signature 604, hashed data 606, and the data 608 (e.g., an application or file of an application to be downloaded, installed, etc.). The processing circuit is configured to execute a certificate verification module which is configured to determine whether the certificate should be verified. If so, at a step 612, a public key is extracted from certificate information 602 and used to decrypt signature 604 (step 614). The verification module is further configured to generate a digest 616 based on a hash of data 608. If hashed data 606 matches the digest 616 (at step 618), and the decrypted signature 614 matches signature 604 (step 620), the processing circuit determines that the certificate is valid.

According to one exemplary embodiment, when the user elects to use an application, the .jnlp extension of the file name in the URL will cause an application discovery module to use a mime extension processing subsystem to handle the contents of the file. The mime extension processing system may comprise a mime-handler-registry and an instance of a mime-handler to handle the application/x-java-jnlp-file mime type.

According to one exemplary embodiment, for a download operation, the JNLP program operating on the mobile computing device is configured to download and parse the JNLP file associated with the application to be downloaded and, if there are no errors, to store the JNLP file in a cache or other memory using the following syntax: cache/<FullyResolvedURL><version>.jnlp. A parser module (e.g., a JNLP mime parser) operating on the mobile device is then configured to download and cache the referenced resources including JAR files and to cache them using a similar syntax as that for jnlp files: /cache/<FullyResolvedURL><version>.jar.

The processing circuit of the mobile device may be configured to operate an installation time security check process. Once all the files are downloaded and cached by the JNLP mime parser, a JNLP installation security verifier is invoked. This security verifier is configured to verify the signatures on JAR files, inspect the security attributes in the JNLP file and notify the user if user permission is required. The verification process of FIG. 6 may be used in one exemplary embodiment. If user permission is required, the user is prompted with an appropriate message and if the user agrees to the request, the permissions are stored in the security attributes repository for the application.

The processing circuit of the mobile device may be configured to execute an application browser refresh process. Once the application has passed security validation, the application browser operating on the mobile device is requested to refresh its cache so that the new application appears in its list of applications that can be launched. The application browser now points to the local cache of files rather than to the original URLs for the JNLP, jar, etc. files.

According to one exemplary embodiment, the mobile computing device may be configured to validate a co-signed application (e.g., an application signed by a plurality of certification authorities, one of which may be the device manufacturer). A co-signing approach may be allowed by the server and/or mobile device, in which multiple signatures on an application are provided. The co-signing can be validated, in one example, using transitive closure to determine the trustworthiness of signatures when there are multiple signers of the application or JARs thereof. If the mobile device finds one or more signers signed all the JARs, then the trustworthiness is the same as the trustworthiness of the most trustworthy signer. When there are no signers that did not sign all the jars, then the trustworthiness is based on the minimum level of trust while calculating the transitive closure. For example, if three signers, S1, S2, and S3 have trust levels of T1, T2, and T3 where T1′<T2<T3, and there are three jars, J1, J2, and J3, and J1 is signed by S1, J2 is signed by S2, and J3 is signed by S3. Then the trustworthiness of an application comprising J1, J2, and J3 is only that of T1. If J1 and J2 are signed by S1 and S2, and J3 is signed by S3, then the trust of an application comprising J1, J2 and J3 is T2. If J1 and J2 are signed and J3 is unsigned, then the application comprising J1, J2, and J3 is untrustworthy. If J1, J2, and J3 are each signed by all three signers, S1, S2, and S3, then the trustworthiness is that of T3.

A manifest file stored in the JAR package provides information regarding what the device manufacturer knows about the product, such as the application version, when signed, author, etc.

Shared JARs coming from different vendors which are signed using different trust ratings (example: verified vs. unverified) can be detected during transitive closure operations.

Application or signature validation processes operating on the mobile device can also take into account device policies which can have user preferences or portal ratings including white-lists and black-lists, etc. CA-signed certificate usage: whether signed by a certificate authority unassociated with Palm, or by a Palm-authorized certificate authority, validation can proceed similarly (e.g., validation, white lists, etc.). The application validation cycle time may be the same regardless of how the application is signed.

Launching, Running the Application and Updates

Once the application has been downloaded and installed, the application may be launched. According to one embodiment, a loader application, such as PalmSecureClassLoader, may be used, which is a software component of the system configured to launch and verify the security of the application. Reference to files are preferably efficient. Resource retrieval is preferably fast. The main entry point for the application is defined in the JNLP file. The processing circuit is configured to load the JAR files in the order they are set forth or listed in the JNLP file.

The launching of an application may start off or initiate an update thread or other code operable in the background (e.g., transparent to the user) that checks for JNLP and JAR file updates by way of wireless communication with the device manufacturer's download server. The initial test for updates is a change in a time-stamp of an HTTP Response with respect to the file cache timestamp. A file cache timestamp is a data value recorded when the application is first downloaded for launch. The data value is cached on the mobile device. If the time stamp is later than the cache file stamp, the new resource is downloaded and checked for version upgrade, which may use any of the download or installation steps described herein. Signatures may be checked once only, not every time the JNLP update is run. In one embodiment, the mobile device may not perform a run-time signature check because of the effect on performance speed of the device. Byte-code verification (e.g., verifying the machine code of the application) may be done only at install time.

Running the application may also comprise a security check, which may performed only for runtime API access to services and protected APIs. File system protection is a highest priority and signed applications benefit from the fact that each application gets its own Linux user identity, a separate partition is created for all of user's data, and read and write operations are over-ridden using class loader information to force applications to have their home directory and below.

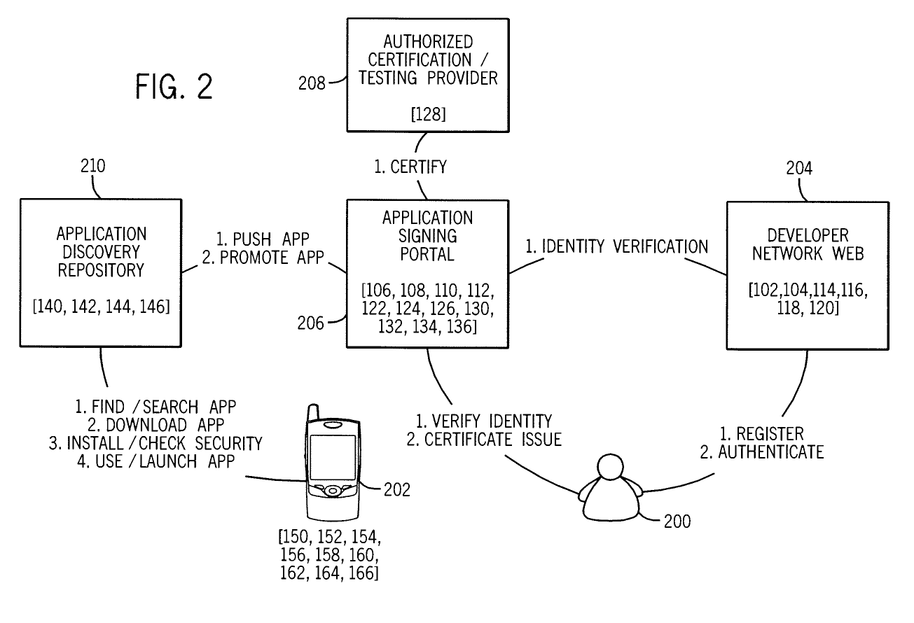

Referring now to FIG. 2, a schematic diagram is shown illustrating entities associated with a secure application signing system and method. Reference numerals in brackets in FIG. 2 indicate which entity of FIG. 2 is associated with steps/blocks of FIG. 1. A developer 200 uses a networked computer to access a developer network web site 204 operating on a server computer to register as a developer with the device manufacturer and to submit an application for signing or submit an externally signed application for discovery. An application signing portal 206 is configured to verify the identity of developer 200 and issue a developer certificate to the developer. Application signing portal 206 is further configured to certify an application uploaded by developer, for example via an authorized certification/testing provider 208. A signed application is then pushed to an application discovery repository 210 (e.g., a web site, server, etc.) configured to make the signed application available to mobile computing devices 202. Repository 210 may promote and publish signed (or unsigned) applications, making them available for download, install, and/or launch by devices 202. Device 202 is configured to find/search for applications, download applications, install and check security, and/or launch and use applications.

Although shown functionally as distinct boxes in FIG. 2, portions or all of elements 204, 206, 208 and 210 may be performed by a single server computer or entity or multiple server computers, logic modules or entities, in various embodiments.

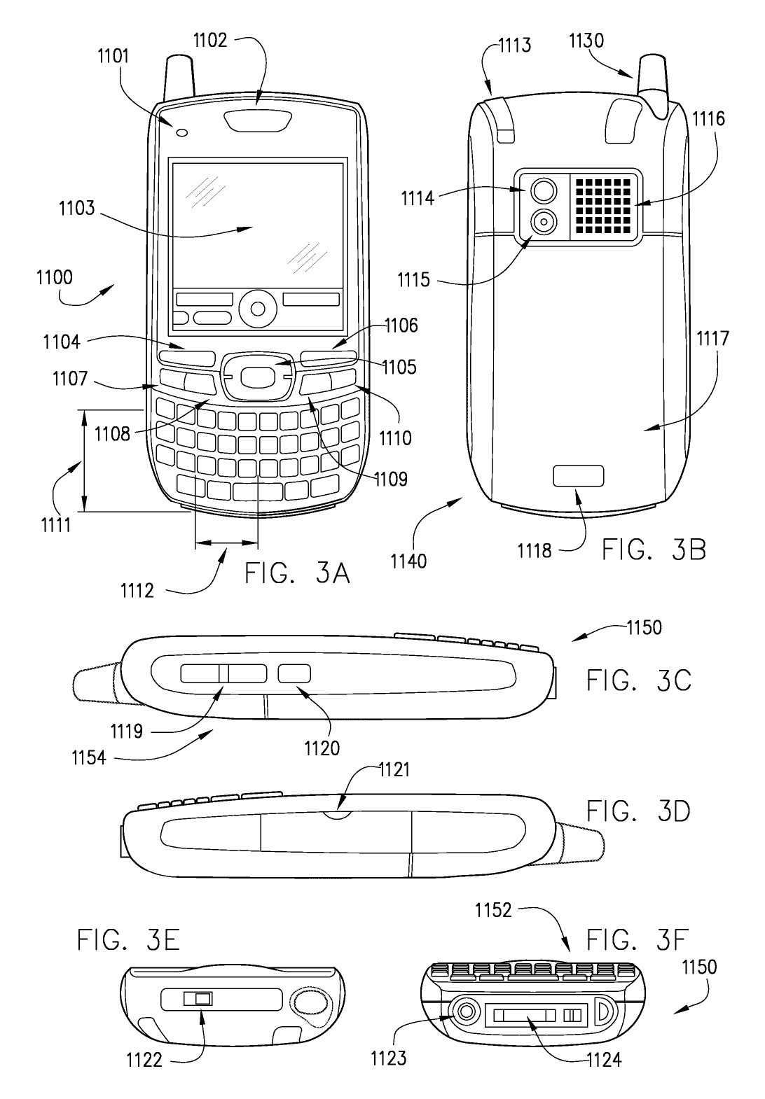

Referring to FIGS. 3A through 3F, a mobile computing device 1100 is shown from various angles, according to an exemplary embodiment. FIG. 3A is a front view of device 1100; FIG. 3B is a rear view of device 1100; FIGS. 3C and 3D are side views of device 1100; and FIGS. 3E and 3F are top and bottom views of device 1100. The device may be any type of communications or computing device (e.g., a cellular phone, other mobile device, digital media player (e.g., audio or audio/video), personal digital assistant, etc.).

Device 1100 may be a smart phone, which is a combination mobile telephone and handheld computer having personal digital assistant (“PDA”) functionality. The teachings herein can be applied to other mobile computing devices (e.g., a laptop computer) or other electronic devices (e.g., a desktop personal computer, etc.). PDA functionality can comprise one or more of personal information management, database functions, word processing, spreadsheets, voice memo recording, location-based services, device backup and lock, media playing, internet browsing, etc. and is configured to synchronize personal information (e.g., contacts, e-mail, calendar, notes, to-do list, etc.) from one or more applications with a computer (e.g., desktop, laptop, server, etc.). Device 1100 is further configured to receive and operate additional applications provided to device 1100 after manufacture, e.g., via wired or wireless download, Secure Digital card, etc.

Device 1100 may be a handheld computer (e.g., a computer small enough to be carried in a typical front pocket found in a pair of pants or other similar pocket), comprising such devices as typical mobile telephones and PDAs, but the term “handheld” and the phrase “configured to be held in a hand during use” excluding typical laptop computers and tablet personal computers (“PCs”) for purposes of this disclosure. In alternative embodiments, the teachings herein may extend to laptop computers, tablet PCs, desktop PCS, and other electronic devices. In some embodiments, the teachings herein may extend to any electronic device in which a CEA-936A standard is used, or to other electronic devices. The various input devices, audio circuits, and other devices of device 1100 as described below may be positioned anywhere on device 1100 (e.g., the front side of FIG. 3A, the rear side of FIG. 3B, the sides of FIGS. 3C and 3D, etc.).

Device 1100 includes various user input devices therein. Examples of functions the user input devices may have include a send button 1104 configured to select options appearing on display 1103 and/or send messages, a 5-way navigator 1105 configured to navigate through options appearing on display 1103, a power/end button 1106 configured to select options appearing on display 1103 and to turn on display 1103, a phone button 1107 usable to access a phone application screen, a calendar button 1108 usable to access a calendar application screen, a messaging button 1109 usable to access a messaging application screen (e.g., e-mail, text, MMS, etc.), an applications button 1110 usable to access a screen showing available applications, a thumb keyboard 1111 (which includes a phone dial pad 1112 usable to dial during a phone application), a volume button 1119 usable to adjust the volume of audio output of device 1100, a customizable button 1120 which a user may customize to perform various functions, a ringer switch 1122 usable to switch the device from one mode to another mode (such as switching from a normal ringer mode to a meeting ringer mode), and a touch screen display 1103 usable to select control options displayed on display 1103. The touch screen display 1103 may be configured to sense a finger swipe as a different input than a single press, and may be configured to sense touches at multiple locations on the touch screen simultaneously for functions such as scrolling, expanding, zooming, etc.

Device 1100 also includes various audio circuits. The audio circuits may include phone speaker 1102 usable to listen to information in a normal phone mode, external speaker 1116 louder than the phone speaker (e.g. for listening to music, for a speakerphone mode, etc.), headset jack 1123 to which a user can attach an external headset which may include a speaker and/or a microphone, and a microphone which can be used to pick up audio information such as the user's end of a conversation during a phone call.

Device 1100 may also include a status indicator 1101 that can be used to indicate the status of device 1100 (such as messages pending, charging, low battery, etc.), a stylus slot 1113 for receiving a stylus such as a stylus usable to input data on touch screen display 1103, a digital camera 1115 usable to capture images, a mirror 1114 positioned proximate camera 1115 such that a user may view themselves in mirror 1114 when taking a picture of themselves using camera 1115, a removable battery 1118, and a connector 1124 which can be used to connect device 1100 to either (or both) an external power supply such as a wall outlet or battery charger or an external device such as a personal computer, a global positioning system (“GPS”) unit, a display unit, or some other external device.

Device 1100 may also include an expansion slot 1121 which may be used to receive a memory card and/or a device which communicates data through slot 1121, and a SIM card slot 1117, located behind battery 1118, configured to receive a SIM card or other card that allows the user to access a cellular network.

In various embodiments device 1100 may include a housing 1140. Housing 1140 may be configured to hold a screen in a fixed relationship above a plurality of user input devices in a substantially parallel or same plane. In the fixed relationship embodiment, this fixed relationship excludes a hinged or movable relationship between the screen and plurality of keys in the fixed embodiment.

Housing 1140 could be any size, shape, and dimension. In some embodiments, housing 1140 has a width 1152 (shorter dimension) of no more than about 200 mm or no more than about 100 mm. According to some of these embodiments, housing 1140 has a width 152 of no more than about 85 mm or no more than about 65 mm. According to some embodiments, housing 1140 has a width 1152 of at least about 30 mm or at least about 50 mm. According to some of these embodiments, housing 1140 has a width 1152 of at least about 55 mm.

In some embodiments, housing 1140 has a length 1154 (longer dimension) of no more than about 200 mm or no more than about 150 mm. According to some of these embodiments, housing 1140 has a length 1154 of no more than about 135 mm or no more than about 125 mm. According to some embodiments, housing 1140 has a length 1154 of at least about 70 mm or at least about 100 mm. According to some of these embodiments, housing 1140 has a length 1154 of at least about 110 mm.

In some embodiments, housing 1140 has a thickness 1150 (smallest dimension) of no more than about 150 mm or no more than about 50 mm. According to some of these embodiments, housing 1140 has a thickness 1150 of no more than about 30 mm or no more than about 25 mm. According to some embodiments, housing 1140 has a thickness 1150 of at least about 10 mm or at least about 15 mm. According to some of these embodiments, housing 1140 has a thickness 1150 of at least about 50 mm. According to some embodiments, housing 1140 has a thickness 1150 of 11 mm or less.

In some embodiments, housing 1140 has a volume of up to about 2500 cubic centimeters and/or up to about 1500 cubic centimeters. In some of these embodiments, housing 1140 has a volume of up to about 1000 cubic centimeters and/or up to about 600 cubic centimeters.

Device 1100 may include an antenna 1130 system for transmitting and/or receiving electrical signals. Each transceiver of device 1100 may include individual antennas or may include a common antenna 1130. The antenna system may include or be implemented as one or more internal antennas and/or external antennas.

While described with regards to a handheld device, many embodiments are usable with portable devices which are not handheld and/or with non-portable devices/systems.

Device 1100 may provide voice communications functionality in accordance with different types of cellular radiotelephone systems. Examples of cellular radiotelephone systems may include Code Division Multiple Access (“CDMA”) cellular radiotelephone communication systems, Global System for Mobile Communications (“GSM”) cellular radiotelephone systems, etc.

In addition to voice communications functionality, device 1100 may be configured to provide data communications functionality in accordance with different types of cellular radiotelephone systems. Examples of cellular radiotelephone systems offering data communications services may include GSM with General Packet Radio Service (“GPRS”) systems (“GSM/GPRS”), CDMA/1×RTT systems, Enhanced Data Rates for Global Evolution (“EDGE”) systems, Evolution Data Only or Evolution Data Optimized (“EV-DO”) systems, etc.

Device 1100 may be configured to provide voice and/or data communications functionality through wireless access points (“WAPs”) in accordance with different types of wireless network systems. A wireless access point may comprise any one or more components of a wireless site used by device 1100 to create a wireless network system that connects to a wired infrastructure, such as a wireless transceiver, cell tower, base station, router, cables, servers, or other components depending on the system architecture. Examples of wireless network systems may further include a wireless local area network (“WLAN”) system, wireless metropolitan area network (“WMAN”) system, wireless wide area network (“WWAN”) system (e.g., a cellular network), and so forth. Examples of suitable wireless network systems offering data communication services may include the Institute of Electrical and Electronics Engineers (“IEEE”) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (“PAN”) system, such as a Bluetooth® system operating in accordance with the Bluetooth Special Interest Group (“SIG”) series of protocols.

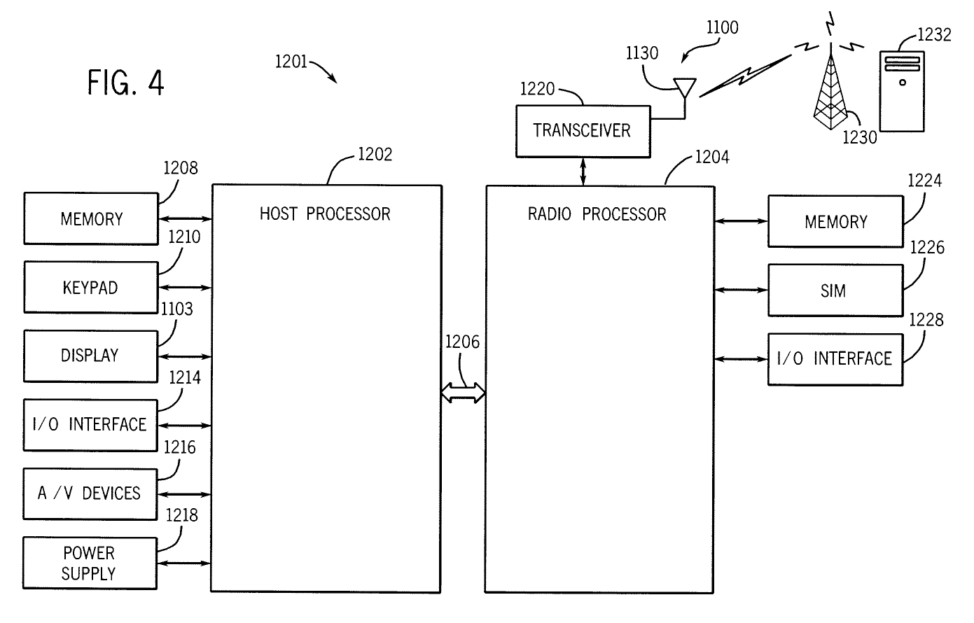

As shown in the embodiment of FIG. 4, device 1100 may comprise a processing circuit 1201 which may comprise a dual processor architecture, including a host processor 1202 and a radio processor 1204 (e.g., a base band processor or modem). The host processor 1202 and the radio processor 1204 may be configured to communicate with each other using interfaces 1206 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth.

The host processor 1202 may be responsible for executing various software programs such as application programs and system programs to provide computing and processing operations for device 1100. The radio processor 1204 may be responsible for performing various voice and data communications operations for device 1100 such as transmitting and receiving voice and data information over one or more wireless communications channels. Although embodiments of the dual processor architecture may be described as comprising the host processor 1202 and the radio processor 1204 for purposes of illustration, the dual processor architecture of device 1100 may comprise one processor, more than two processors, may be implemented as a dual- or multi-core chip with both host processor 1202 and radio processor 1204 on a single chip, etc. Alternatively, a single processor or multiple processors may perform the functions of host processor 1202 and radio processor 1204, such as a single, unified processor that handles host and radio functions, or other multiprocessor topologies which do not rely on the concept of a host. Alternatively, processing circuit 1201 may comprise any digital and/or analog circuit elements, comprising discrete and/or solid state components, suitable for use with the embodiments disclosed herein.

In various embodiments, the host processor 1202 may be implemented as a host central processing unit (“CPU”) using any suitable processor or logic device, such as a general purpose processor. The host processor 1202 may comprise, or be implemented as, a chip multiprocessor (“CMP”), dedicated processor, embedded processor, media processor, input/output (“I/O”) processor, co-processor, field programmable gate array (“FPGA”), programmable logic device (“PLD”), or other processing device in alternative embodiments.

The host processor 1202 may be configured to provide processing or computing resources to device 1100. For example, the host processor 1202 may be responsible for executing various software programs such as application programs and system programs to provide computing and processing operations for device 1100. Examples of application programs may include, for example, a telephone application, voicemail application, e-mail application, instant message (“IM”) application, short message service (“SMS”) application, multimedia message service (“MMS”) application, web browser application, personal information manager (“PIM”) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (“GUI”) to communicate information between device 1100 and a user.

System programs assist in the running of a computer system. System programs may be directly responsible for controlling, integrating, and managing the individual hardware components of the computer system. Examples of system programs may include, for example, an operating system (“OS”), device drivers, programming tools, utility programs, software libraries, an application programming interface (“API”), a GUI, and so forth. Device 1100 may utilize any suitable OS in accordance with the described embodiments such as a Palm OS®, Palm OS® Cobalt, Microsoft® Windows OS, Microsoft Windows® CE, Microsoft Pocket PC, Microsoft Mobile, Symbian OS™, Embedix OS, Linux, Binary Run-time Environment for Wireless (“BREW”) OS, JavaOS, a Wireless Application Protocol (“WAP”) OS, and so forth.

Device 1100 may comprise a memory 1208 coupled to the host processor 1202. In various embodiments, the memory 1208 may be configured to store one or more software programs to be executed by the host processor 1202. The memory 1208 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (“RAM”), dynamic RAM (“DRAM”), Double-Data-Rate DRAM (“DDRAM”), synchronous DRAM (“SDRAM)”, static RAM (“SRAM”), read-only memory (“ROM”), programmable ROM (“PROM”), erasable programmable ROM (“EPROM”), electrically erasable programmable ROM (“EEPROM”), flash memory (e.g., NOR or NAND flash memory), or any other type of media suitable for storing information.

Although the memory 1208 may be shown as being separate from the host processor 1202 for purposes of illustration, in various embodiments some portion or the entire memory 1208 may be included on the same integrated circuit as the host processor 1202. Alternatively, some portion or the entire memory 1208 may be disposed on an integrated circuit or other medium (e.g., hard disk drive) external to the integrated circuit of host processor 1202. In various embodiments, device 1100 may comprise a memory port or expansion slot 1121 (shown in FIG. 3) to support a multimedia and/or memory card, for example. Processing circuit 1201 may use memory port or expansion slot 1121 to read and/or write to a removable memory card having memory, for example, to determine whether a memory card is present in port or slot 1121, to determine an amount of available memory on the memory card, to store subscribed content or other data or files on the memory card, etc.

Device 1100 may comprise a user input device 1210 coupled to the host processor 1202. The user input device 1210 may comprise, for example, a alphanumeric, numeric or QWERTY key layout and an integrated number dial pad. Device 1100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth. Examples of such objects are shown in FIG. 3 as 5-way navigator 1105, power/end button 1106, phone button 1107, calendar button 1108, messaging button 1109, applications button 1110, thumb keyboard 1111, volume button 1119, customizable button 1120, and ringer switch 1122.

The host processor 1202 may be coupled to a display 1103. The display 1103 may comprise any suitable visual interface for displaying content to a user of device 1100. For example, the display 1103 may be implemented by a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

Device 1100 may comprise an I/O interface 1214 coupled to the host processor 1202. The I/O interface 1214 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a PC. In various implementations, device 1100 may be configured to transfer and/or synchronize information with the local computer system.

The host processor 1202 may be coupled to various audio/video (“A/V”) devices 1216 that support A/V capability of device 1100. Examples of A/V devices 1216 may include, for example, a microphone, one or more speakers, an audio port to connect an audio headset, an audio coder/decoder (codec), an audio player, a digital camera, a video camera, a video codec, a video player, and so forth.

The host processor 1202 may be coupled to a power supply 1218 configured to supply and manage power to the elements of device 1100. In various embodiments, the power supply 1218 may be implemented by a rechargeable battery, such as a removable and rechargeable lithium ion battery to provide direct current (“DC”) power, and/or an alternating current (“AC”) adapter to draw power from a standard AC main power supply.

As mentioned above, the radio processor 1204 may perform voice and/or data communication operations for device 1100. For example, the radio processor 1204 may be configured to communicate voice information and/or data information over one or more assigned frequency bands of a wireless communication channel. In various embodiments, the radio processor 1204 may be implemented as a communications processor using any suitable processor or logic device, such as a modem processor or baseband processor. Although some embodiments may be described with the radio processor 1204 implemented as a modem processor or baseband processor by way of example, it may be appreciated that the embodiments are not limited in this context. For example, the radio processor 1204 may comprise, or be implemented as, a digital signal processor (“DSP”), media access control (“MAC”) processor, or any other type of communications processor in accordance with the described embodiments. Radio processor 1204 may be any of a plurality of modems manufactured by Qualcomm, Inc. or other manufacturers.

Device 1100 may comprise a transceiver 1220 coupled to the radio processor 1204. The transceiver 1220 may comprise one or more transceivers configured to communicate using different types of protocols, communication ranges, operating power requirements, RF sub-bands, information types (e.g., voice or data), use scenarios, applications, and so forth. For example, transceiver 1220 may comprise a Wi-Fi transceiver and a cellular or WAN transceiver configured to operate simultaneously.

The transceiver 1220 may be implemented using one or more chips as desired for a given implementation. Although the transceiver 1220 may be shown as being separate from and external to the radio processor 1204 for purposes of illustration, in various embodiments some portion or the entire transceiver 1220 may be included on the same integrated circuit as the radio processor 1204.

Device 1100 may comprise an antenna system 1130 for transmitting and/or receiving electrical signals. As shown, the antenna system 1130 may be coupled to the radio processor 1204 through the transceiver 1220. The antenna system 1130 may comprise or be implemented as one or more internal antennas and/or external antennas. Radio tower 1230 and server 1232 are shown as examples of potential objects configured to receive a signal from antenna system 1130.

Device 1100 may comprise a memory 1224 coupled to the radio processor 1204. The memory 1224 may be implemented using one or more types of machine-readable or computer-readable media capable of storing data such as volatile memory or non-volatile memory, removable or non-removable memory, erasable or non-erasable memory, writeable or re-writeable memory, etc. The memory 1224 may comprise, for example, flash memory and secure digital (“SD”) RAM. Although the memory 1224 may be shown as being separate from and external to the radio processor 1204 for purposes of illustration, in various embodiments some portion or the entire memory 1224 may be included on the same integrated circuit as the radio processor 1204. Further, host processor 1202 and radio processor 1204 may share a single memory.

Device 1100 may comprise a subscriber identity module (“SIM”) 1226 coupled to the radio processor 1204. SIM 1226 may comprise, for example, a removable or non-removable smart card configured to encrypt voice and data transmissions and to store user-specific data for allowing a voice or data communications network to identify and authenticate the user. SIM 1226 also may store data such as personal settings specific to the user.

Device 1100 may comprise an I/O interface 1228 coupled to the radio processor 1204. The I/O interface 1228 may comprise one or more I/O devices to enable wired (e.g., serial, cable, etc.) and/or wireless (e.g., WiFi, short range, etc.) communication between device 1100 and one or more external computer systems.

In various embodiments, device 1100 may comprise location or position determination capabilities. Device 1100 may employ one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc.

In various embodiments, device 1100 may comprise dedicated hardware circuits or structures, or a combination of dedicated hardware and associated software, to support position determination. For example, the transceiver 1220 and the antenna system 1130 may comprise GPS receiver or transceiver hardware and one or more associated antennas coupled to the radio processor 1204 to support position determination.

The host processor 1202 may comprise and/or implement at least one location-based service (“LBS”) application. In general, the LBS application may comprise any type of client application executed by the host processor 1202, such as a GPS application configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (“POI”) such as restaurants, hotels, landmarks, and entertainment venues, and other types of LBS services in accordance with the described embodiments.

Radio processor 1204 may be configured to invoke a position fix by configuring a position engine and requesting a position fix. For example, a position engine interface on radio processor 1204 may set configuration parameters that control the position determination process. Examples of configuration parameters may include, without limitation, location determination mode (e.g., standalone, MS-assisted, MS-based), actual or estimated number of position fixes (e.g., single position fix, series of position fixes, request position assist data without a position fix), time interval between position fixes, Quality of Service (“QoS”) values, optimization parameters (e.g., optimized for speed, accuracy, or payload), PDE address (e.g., IP address and port number of LPS or MPC), etc. In one embodiment, the position engine may be implemented as a QUALCOMM® gpsOne® engine.

While the server system of FIG. 1 is described with reference to a device manufacturer operating the application signing system and method, in alternative embodiments other entities may operate the system and method.

In various embodiments, the steps described in FIGS. 1, 2, 5, 6 and 7 may be operable on one or more servers, and may further be stored as one or more software programs or logic modules configured to be executed by a processing circuit. The software programs or logic modules may be stored on any machine-readable or computer-readable media capable of storing data such as volatile memory or non-volatile memory, removable or non-removable memory, erasable or non-erasable memory, writeable or re-writeable memory, a database, a CD-ROM, a memory associated with a web server, or other media. Reference to a module, unit, logic, or other functional unit may comprise software and/or hardware (e.g., circuitry), which may be operable on one or more same or different processing circuits.

According to one exemplary embodiment, a mobile computing device comprises a memory, a wireless transceiver configured to communicate wirelessly with a server computer, and a processing circuit configured to download a certificate revocation list from the server computer and to store the certification revocation list in memory. The processing circuit may be configured to receive a user selection of an application for download and to determine whether the application for download has a certificate on the certificate revocation list. The processing circuit may be configured to display information about the application if the application either does not have a valid certificate or has a certificate which is revoked.

According to another exemplary embodiment, a mobile computing device comprises a wireless transceiver configured to communicate wirelessly with a server computer and a processing circuit configured to select an application for download, to determine one or more signatures associated with the application, and to determine whether to download or install the application based on the one or more signatures. The application may be associated with a plurality of signatures from a plurality of different certification authorities. The processing circuit may be configured to use a transitive closure process to determine whether to download the application based on the plurality of signatures.

According to some advantageous embodiments, one or more of the steps of FIG. 1 may be carried out without user input, or automatically, to simplify and streamline the process.

According to other advantageous embodiments, one or more of the steps of FIG. 1 may be carried out by modules or programs under the control a single entity, such as a device manufacturer.

According to yet other advantageous embodiments, one or more of the steps of FIG. 1 may be carried out by modules in communication with one another on a server, such as a server computer or server farm. For example, the signing server or module may be tightly coupled in communication with the catalog server or module such that as soon as an application is signed, certified and/or approved, the application is promptly available for download by mobile computing devices.

While the exemplary embodiments illustrated in the FIGs. and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A system for facilitating approval of an application and for making the application available for download by mobile computing devices, comprising;
a first module configured to receive a user input received from a software development environment; and
a second module configured to initiate an application approval process based on the user input; and
a third module configured to make the application available for download by mobile computing devices based on the approval process.

2. The system of claim 1, wherein the third module is configured to make the application available for wireless download to the mobile computing devices.

3. The system of claim 2, wherein the third module is a catalog module configured to receive a user search request, provide search results representing applications available for download, and to receive a user selection of an application for download.

4. The system of claim 1, further comprising a certification module configured to certify the application based on at least one certification criteria.

5. The system of claim 1, further comprising a signing module configured to sign the application using a digital certificate.

6. The system of claim 5, further comprising an application upload module configured to receive the application, wherein the application upload module is configured to upload an externally signed application in a first mode and to upload an unsigned application for signing by the signing module in a second mode.

7. The system of claim 6, wherein the externally signed application is signed by a third party certification authority not operating the application upload module.

8. The system of claim 1, further comprising a verification module configured to verify an identity of a developer of the application.

9. The system of claim 8, wherein the verification module is configured to generate a certificate for the developer based on the verification of identity of the developer.

10. The system of claim 9, further comprising a signing module configured to sign the application using the certificate.

11. A method of making available for download a signed application, comprising:
receiving at a server a request from a developer to initiate an application approval process;
signing the application using the server; and
storing the signed application in an application repository for download by mobile computing devices.

12. The method of claim 11, wherein the server computer is operated by a manufacturer of the mobile computing devices.

13. The method of claim 11, wherein the step of storing is performed after signing the application without manual input from a human.

14. The method of claim 11, further comprising receiving an externally signed application and uploading the externally signed application to the server, wherein the externally signed application is signed by a third party certification authority not operating the server.

15. The method of claim 11, further comprising verifying an identity of the developer.

16. The method of claim 15, further comprising generating a certificate for the developer based on the verification of identity of the developer.

17. The method of claim 16, wherein the application is signed using the certificate.

18. The method of claim 11, further comprising testing the application with a test module and signing the application based on a result of the test.

19. A system for interfacing with a software developer, comprising:
a first module configured to receive a request from a software developer;
a second module configured to verify the developer identity;
a third module configured to issue a signed developer certificate if the developer identity is verified;
a fourth module configured to sign an application using the certificate; and
a fifth module configured to make the signed application available for download by handheld computing devices.

20. The system of claim 19, wherein the application is configured to operate on a mobile computing device, wherein a manufacturer of the mobile computing device operates the system.
